(19) United States
(12) Patent Application Publication
(10) Pub. No.: US 2002/0055918 A1
(43) Pub. Date: May 9, 2002

(54) Operating room resource management system incorporating an interactive, visual method for coordinating multiple, interdependent

(76) Inventors: Patrick Hlathein, Madison, WI (US); Steve Larsen, Madison, WI (US); Aaron Patterson, Madison, WI (US)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/969,907

(22) Filed: Oct. 3, 2001

Related U.S. Application Data
(60) Provisional application No. 60/246,831, filed on Nov. 8, 2000.

(51) Int. Cl. G06F 7/00

(52) U.S. Cl. 707/1

(57) ABSTRACT

A method of building a surgical case for a patient and an identified surgeon wherein the method includes retrieving a set of events for the surgical case, graphically depicting the events as a group of nested boxes, and providing an alert indicator when a relationship between the events is improperly coordinated.

### CROSS-REFERENCE TO RELATED APPLICATIONS

This application claims priority to U.S. Provisional Application Ser. No. 60/246,831, entitled “An Operating Room Resource Management System Incorporating an Interactive, Visual Method For Coordinating Multiple, Interdependent Events,” filed Nov. 8, 2000 (attorney docket no. 29794/36769), the disclosure of which is hereby expressly incorporated herein by reference.

### FIELD OF THE INVENTION

The present invention relates generally to management and coordination of resources, and more specifically, the invention relates to a system to facilitate operating room resource coordination by displaying a hierarchical system to visually represent to the software user the interdependent nature of the events involved.

### BACKGROUND OF THE INVENTION

An operating room presents a significant challenge to the development of computer software that aids users in the efficient management and scheduling of hospital staff and resources. For a given surgical case, there are a number of procedures that must be performed and a number of people, of different roles, who, at varying times during the case, must perform those procedures. The relationships between so many variables are complex and interdependent, and they create an environment where altering one relationship can have a ripple effect on other relationships. For example, given a fixed amount of available time, changing the amount of time allocated to one procedure can affect the amount of time allocated to another procedure, which in turn, can affect all of the staff members required to perform those procedures.

The most common method for orchestrating the coordination of multiple, interconnected events at different, overlapping times is to enter the start time, end time, and the total required time of each event into a table or spreadsheet format. However, when allocating time to various hospital staff and resources, if one event cannot take place until another is finished, the start time of the second event must be calculated from the end time of the first event, and any subsequent changes to the times for one of the events necessitates a recalculation of the times of the other. Also, when some events are required to overlap each other, or when one or more events must happen within the time-frame of another event, the use of a spreadsheet format can make it difficult to discern the proper relationship between the various events. Thus, when errors are made in the event's beginning and ending times, it may not be obvious where the calculation mistake was made and what value should be changed to remedy it. Given the likely proliferation of multiple, interdependent events in an operating room setting, a table or a spreadsheet entry method is, at best, complicated and, at worst, utterly confusing to users.

Some software manufacturers have used systems with horizontal bar charts to graphically display the time relationships between the different tasks in a project. These systems, such as Microsoft Project, display the interconnected nature of events that depend on each other's start and end times as well as the hierarchical nature of some events, but poorly visually represent the embedded nature of the events and do not provide satisfactory preparatory scheduling information.

There is a demonstrated need for large healthcare organizations to be able to manage and coordinate a large group of embedded events. None of the previous systems satisfied this need.

### BRIEF DESCRIPTION OF THE DRAWINGS

FIG. 1 is a flowchart representation of the primary steps needed in an operating room resource management system in accordance with a preferred embodiment of the invention.

FIG. 2 is a block diagram of nested boxes representing a series of multiple embedded events in accordance with a preferred embodiment of the invention.

FIG. 3 is a macro level flow chart of a preferred embodiment of the invention.

FIG. 4 is a flow chart representation of what happens when a user alters an Event A in a preferred embodiment of the invention.

FIG. 5 is a flow chart representation of what happens when a user alters an Event B in a preferred embodiment of the invention.

FIG. 6 is a flow chart representation of what happens when a user alters an Event C in a preferred embodiment of the invention.

FIG. 7 is a flow chart representation of what happens when a user alters an Event D in a preferred embodiment of the invention.

FIG. 8 is a flow chart representation of what happens when a user alters an Event E in a preferred embodiment of the invention.

FIG. 9 is a flow chart representation of what happens when a user alters an Event F in a preferred embodiment of the invention.

FIG. 10 is a flow chart representation of what happens when a user alters an Event G in a preferred embodiment of the invention.

FIG. 11 is a flow chart representation of what happens when a user alters an Event H in a preferred embodiment of the invention.

FIG. 12 is a flow chart representation of what happens when a user alters an Event I in a preferred embodiment of the invention.

FIG. 13 is a flow chart representation of what happens when a user alters an Event J in a preferred embodiment of the invention.

FIG. 14 is a flowchart representation of the steps required to create a surgical case in accordance with a preferred embodiment of the invention.

FIG. 15 is a flowchart representation of the steps required to schedule a surgical case in accordance with a preferred embodiment of the invention.

FIG. 16 is a flowchart representation of some of the steps necessary to build a surgical procedure for a patient.

FIGS. 17 and 18 illustrate exemplary web pages entering a case.

FIGS. 19 and 20 illustrate exemplary web pages for coordinating multiple, interdependent events.

### DETAILED DESCRIPTION OF THE PREFERRED EMBODIMENTS

According to a preferred embodiment of the invention, an interactive, graphical system for managing multiple embedded events connected to a scheduling engine provides users the ability to see and alter the dependant relationships between the events through a hierarchical display of nested “boxes.” These boxes are visually represented as being contained one within another. When an inappropriate alteration is made to one of the events, instant visual feedback is given to the user in the form of brightly colored indicators within the boxes. When all of the events in the visual system have been properly coordinated, the resulting case can be scheduled at an appropriate time for all involved, using an interconnected scheduling engine.

A system comprising the above mentioned features could prove revolutionary for many different applications. For example, a hospital operating room is one environment where such a hierarchical system would be extremely helpful. In this environment, such a system would allow the staff, resources, and procedures of a surgical case to be scheduled at an appropriate time for all equipment, facilities, and employees involved. While the invention may be implemented in a plethora of environments, the one embodiment hereafter described will be for the coordination of multiple, interdependent, embedded events in a surgical case in a hospital operating room environment.

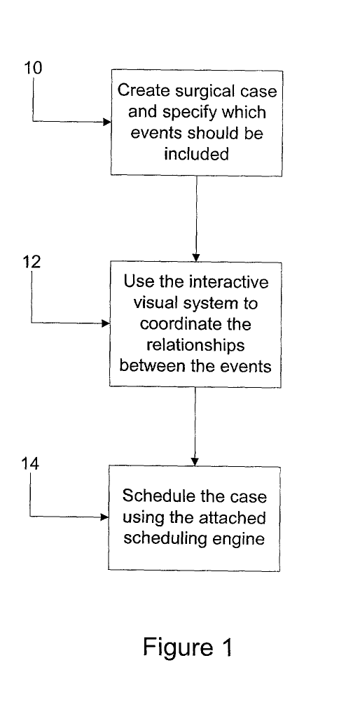

FIG. 1 is a flowchart depicting the three main steps in an operating room resource management system incorporating an interactive, visual method for coordinating multiple, interdependent events. For the purposes of this description, an event (shown as a box in the figures) refers to the concept of an amount of time allocated to a person, resource, or procedure for the purpose of scheduling and time management. Likewise, in an operating room setting, the term “case” is used to describe the combination of events and or procedures comprising a surgery. This includes people (e.g. staffing), procedures, and resources (e.g. equipment, instruments, supplies, drugs, etc.). For example, the events included in most surgeries include: a setup time for the surgery, a time allocated to a patient for the surgery, and a time allocated for cleaning up after the surgery.

A first step 10 in coordinating so many variables is to create the case by identifying which events are needed within it. A preferred method of identifying the events required is to first identify the doctor or surgeon who will be performing the medical procedure on the patient. Once the patient, the surgeon, and the procedure have been identified and entered into the system, a database is queried to provide a template or default list of suggested events. A possible database may be the EHIS Database by Epic Systems Corporation in Madison, Wis. The database contains a template for each procedure that includes the events that the hospital and department require and possibly suggest. Ideally, the database will also contain the specific preferences the surgeon has for a given procedure. In other words, it is the nature of the procedure being performed, along with the facility and the surgeon that determine the set of events to be scheduled. If the facility's set of events is incomplete or inaccurate, the system user is allowed, and encouraged, to modify the set of events to develop a modified set of events for the surgical case. This may include adding additional events or deleting events. Similarly, if the surgeon's preferences have not been input into the database or are incomplete or inaccurate, they too may be modified by adding or deleting events. The system may be configured to prompt the user to ensure that the set of events is complete and accurate. If the procedure to be performed by the surgeon is new, and thus no defaults have been entered into the database, the system user has two options. First, the user may retrieve from the database a set of events for a similar procedure and modify the set of events to incorporate the differences necessitated by the new procedure. Or second, the user may retrieve from the database a base template that prompts the user when building the set of events for the new procedure.

A second step 12 includes orchestrating the relationships between the events, using the interactive visual system. The interactive visual graphically depicts a set of events as a group of nested boxes. Examples of nested boxes will be shown in subsequent figures. Visually presenting the events as a group of nested boxes allows a user to better comprehend the relationships between the events.

The graphical depiction of events also includes alert indicators to warn a user when a relationship between the events is improperly coordinated. To remove the alert indicator, the user is able to manipulate the boxes to coordinate the relationships between the events in such a way that a fully coordinated surgical case is developed. Once the surgical case is coordinated and all warnings have been addressed, the user proceeds to a scheduling step 14.

The scheduling step 14 includes forwarding the coordinated case to a scheduling engine. When attempting to schedule the coordinated case, the user also selects a date and time to schedule the surgical case. The scheduling engine then automatically checks the availability of the set of resources required for the surgical case. It is at this time that the scheduling engine checks the availability for the requested time of the facility, specific pieces of equipment, specific people, etc. If there is a conflict in scheduling, the user will be notified and asked to select a different time or modify the set of events to eliminate the scheduling conflict. Once a coordinated case is accepted for scheduling, the required resources are reserved to ensure their availability for the upcoming surgical case.

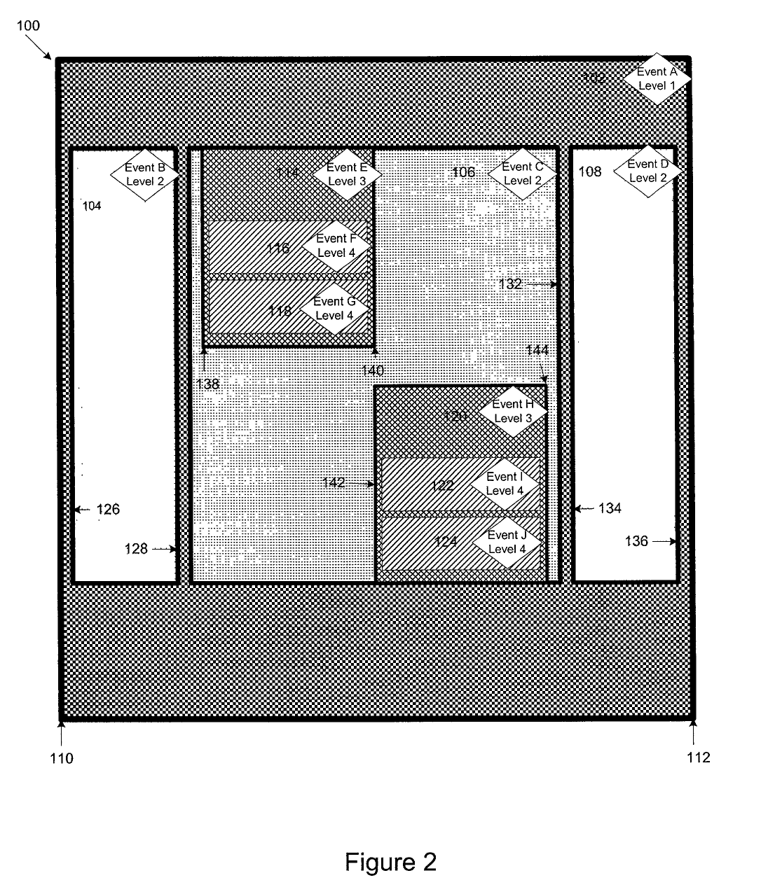

FIG. 2 is a block diagram 100 illustrating a preferred embodiment of a system of nested boxes used to visually represent and manage a series of multiple embedded events in order to facilitate the scheduling of resources. For the purposes of this embodiment, a “box” refers to the appearance of the rectangular shape used to represent an event. Each box on the diagram represents an event, and each event represents a specific amount of allocated time. For these boxes, the left edges represent the beginning of the events and the right edges represent the end of the events. In other words, the widths of the boxes directly correspond to the quantities of time allocated to the particular events. Displaying one smaller “contained” box superimposed on a larger “containing” box represents the concept of embedded events. For the purpose of this description, “embedded” refers to the concept of one event being contained in and dependent on another.

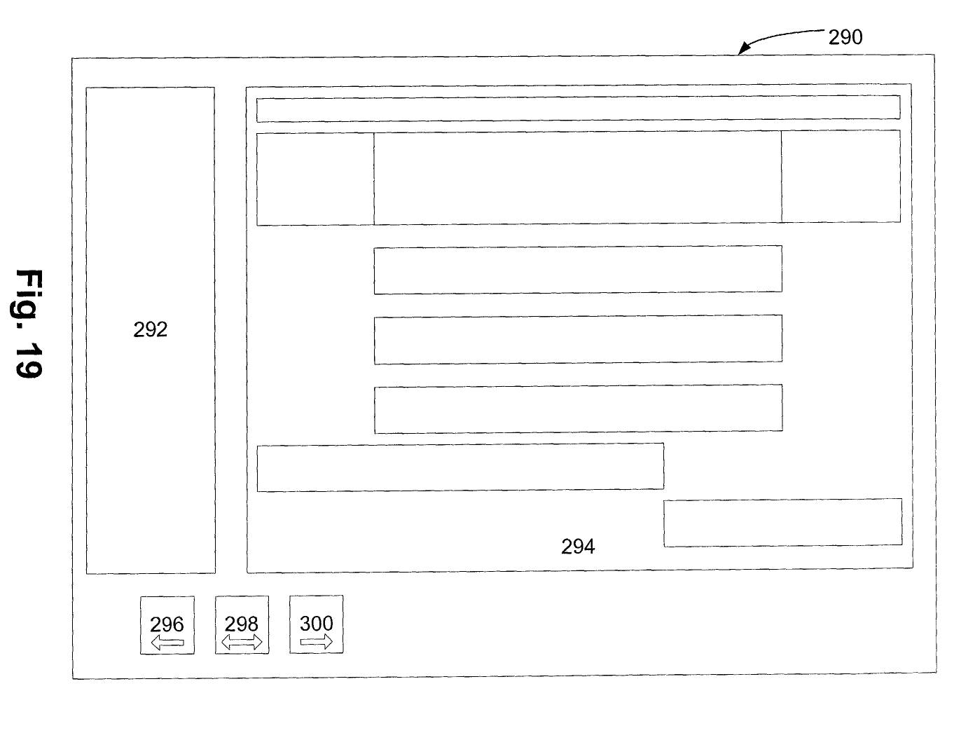

The size of the boxes can be altered, thereby adjusting the amount of time being allocated to the event. In this embodiment, there are two primary methods of altering the size of the boxes. One is to use a peripheral device such as a mouse, keyboard or light-pen to expand the edge of a box left or right. A second method is by selecting an event with a peripheral device and using one of three methods to automatically “stretch” the event to the right container edge, the left container edge, or both. The ability to automatically stretch a box is accomplished by graphically designing three buttons that would have a left arrow on one button, a right arrow on a second button and a third button with arrows pointing both to the left and the right. This feature is shown in FIG. 19. There could be other methods implemented for altering box sizes by a predetermined amount. For example, specifying an exact numeric value through a keyboard for the height or width of a cell or box. Also, if one box is contained by another box, it should not extend beyond the edge of the containing box, in which case the system user would either be warned or would be prevented from doing so.

An Event A 102 is the largest box, and it contains all the other boxes. It is the first level in the hierarchy of embedded events, and it represents the total amount of time, from a beginning 110 to an end 112, available for the embedded events at the second level of the hierarchy. This is the total amount of time scheduled for the procedure. Thus, the amount of time allocated to an Event B 104, plus the amount of time allocated to an Event C 106, plus the amount of time allocated to an Event D 108, is equal to the amount of time allocated to the Event A 102. This is because the Events B 104, C 106, and D 108 are all contained within the Event A 102 at the same level. In addition, since the Event A 102 is not contained by another box, a user is only able to stretch the right edge 112 of the box 102. Furthermore, since the box for the Event A 102 represents an amount of time in minutes, always beginning at zero, the left edge 110 of the box 102 ordinarily cannot be altered. In other words, the left edge 110 of the box represents the beginning of the case in relative time. In a surgical setting, the Event A 102 represents the total amount of time for which the operating room is needed.

The Events B 104, C 106, and D 108, contained within the Event A 102, comprise the second level of the hierarchy. These events can be altered to adjust their allotted time in proportion to the Event A 102, but are contained within the Event A 102. In a surgical setting, the Event B 104 represents the time allocated for the setup of the surgery; the Event C 106 represents the time allocated to the patient for the surgery being performed on him or her; and the Event D 108 represents the time allotted for cleaning up after the surgery. These three events together, in whatever proportions required, comprise the total amount of time for which the operating room is needed and must be equal to the amount of time represented by the Event A 102.

An Event E 114 and an Event H 120, contained within the Event C 106, are at the third level of the hierarchy. Like the events at the second level, these events can be altered by dragging the edge of their respective box or by the stretch method. However, they should not be altered so that they are outside the edge of the Event C 106 which is their container box. In a surgical setting, the Events E 114 and H 120 would represent panels, which are one or more surgical procedures and the surgeons required to perform them.

An Event F 116 and an Event G 118 are contained within the Event E 114. Similarly, an Event I 122 and an Event J 124 are contained within an Event H 120. The Events F 116, G 118, I 122, and J 124 are at the fourth level of the hierarchy. These events, like the others, can be altered, but should not exceed the amount of time allotted to their containing boxes 114 and 120. In a surgical setting, the Events F 116 and I 122 represent procedures required by their respective panels, and the Events G 118 and J 124 represent the physicians required to perform the procedures. Note that there could be multiple procedures per panel as well as multiple physicians.

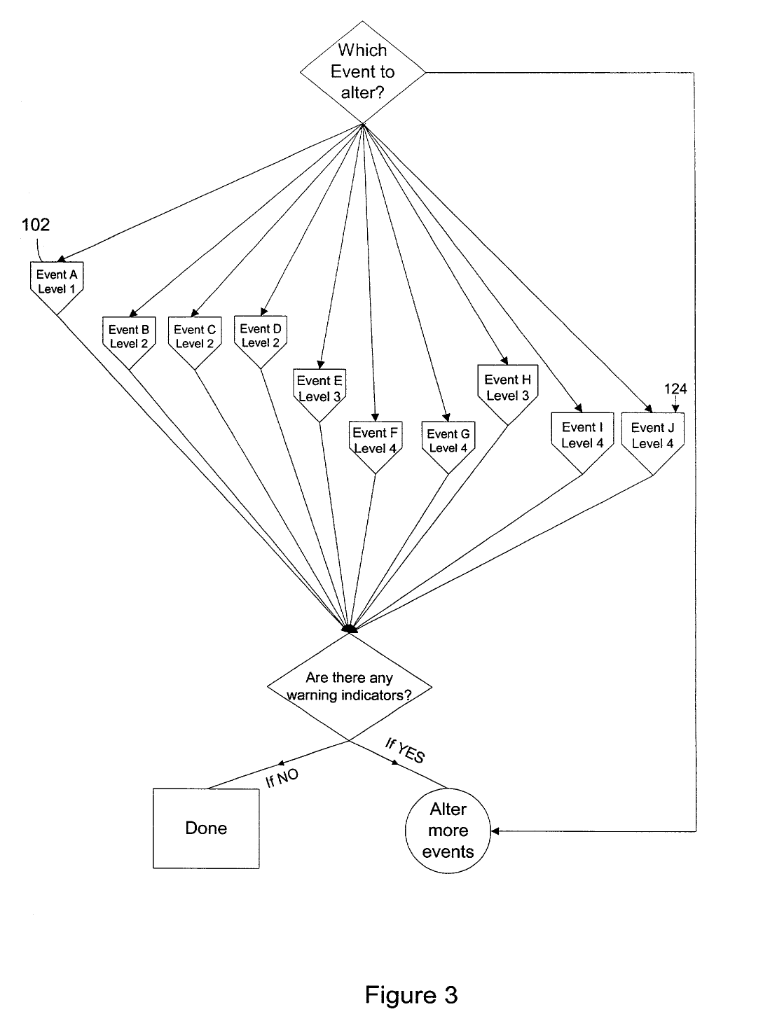

FIG. 3 is a macro level flow chart of a preferred embodiment of the invention. Essentially, the user must decide what event to alter, and thereafter, alter that event. They should keep altering events until no warning indicators are displayed. All events, from A 102 to J 124 can be altered in some way. Each event, however, causes a different series of interactions with the other events, which are depicted in succeeding diagrams.

A preferred method of warning a user when a relationship between events is improperly coordinated is to add a colored hatching to the event(s) causing the warning to occur. The warning indicators may also be visually depicted in a number of different ways. For example, they could be depicted by changing the color of one or more of the boxes that are associated with the scheduling conflict. For instance, the boxes could turn red to indicate that a conflict has occurred. Likewise, the boxes, or the text within the boxes, or both could flash as a means of warning a user of a conflict. Another example would comprise adding a warning symbol. This symbol could include any special typographic character, a geometric shape, a specially designed graphic, or simply a text message. These warning symbols may be placed within or adjacent to the boxes associated with the conflict, or even located in another portion of the display where they would be easily visible. The system generates warnings when there is impermissible alignment, such as overlap, between a plurality of events, or when an event is improperly represented. An example of when an event is improperly represented is when a surgeon is scheduled for only a portion of the time required to perform the surgery.

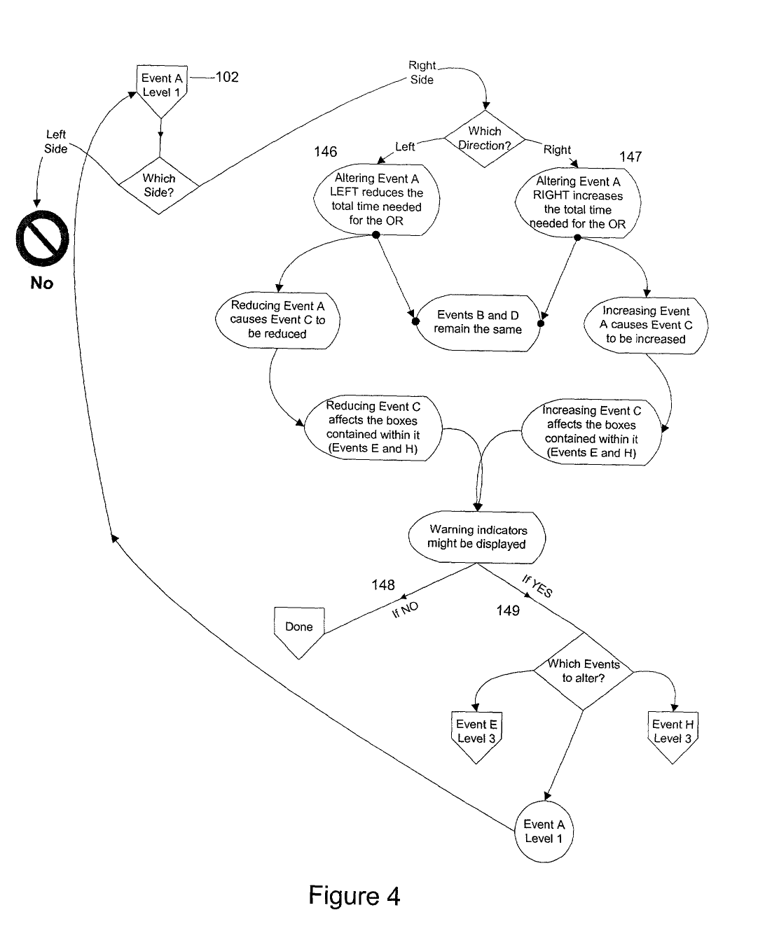

FIG. 4 is a flow chart representation of what happens when a user alters the Event A 102 in a preferred embodiment of the invention. The Event A 102, as also seen in FIG. 2, represents the total amount of time for which an operating room is needed. The total time is the sum of the setup time, the patient time, and the cleanup time. Because the Event A 102 represents an amount of time, the left side 110 of its box ordinarily cannot be altered. This is because the time represented is in minutes, and the left edge 110 of the box represents zero, the beginning of the surgery. The right side 112 of the Event A 102 represents the end of the surgery. Altering the right side 112 of the Event A 102 to the right 147 increases the total amount of time for which the operating room is needed. Altering the right side 112 of the Event A 102 to the left 146 decreases the amount of time for which the operating room is needed. Altering the right side 112 of the Event A 102 in either direction affects the amount of time allocated to the Event C 106, which represents the amount of time devoted to the patient. Altering the Event A 102 automatically alters the Event C 106, which has an affect on the boxes contained within it (the Events E 114 and H 120). If warning indicators are displayed 149 when the Event C 106 is automatically altered, the user should alter the other connected events (E 114, H 120, or A 102) until no warning indicators are displayed 148. Once no more alterations are required, the user can accept the changes. At any time the user can reject the changes.

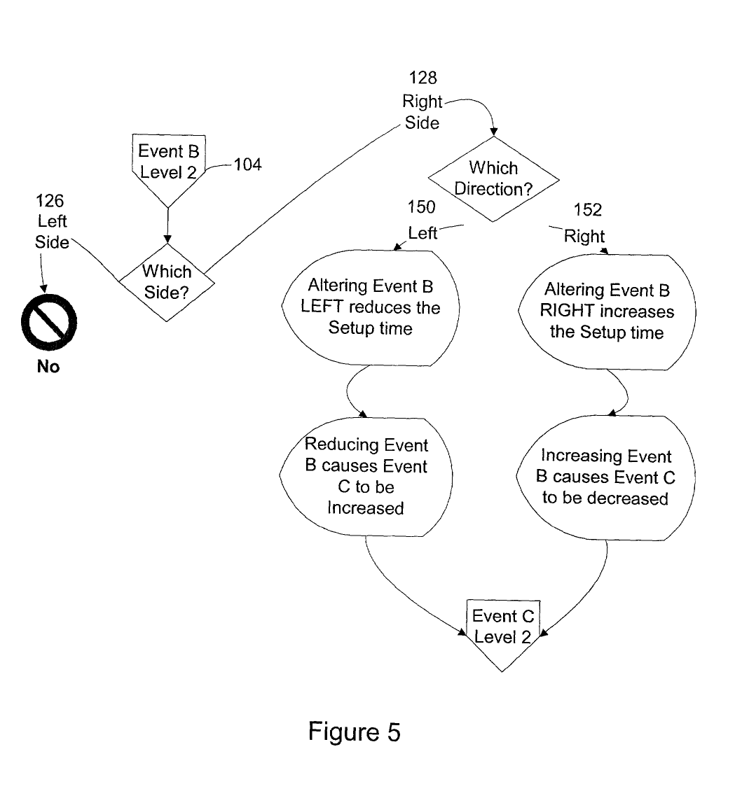

FIG. 5 is a flow chart representation of what happens when a user alters the Event B 104 in a preferred embodiment of the invention. The Event B 104 represents the amount of setup time needed for a surgery, thus the left side of its box 126, as illustrated in FIG. 2, corresponds to the left side 110 of the Event A 102, which represents the beginning of the surgery. Because the left side 126 of the Event B 104, like the left side 110 of the Event A 102, corresponds to the beginning of the surgery, it ordinarily cannot be altered. Altering the right side 128 of the Event B 104 to the right 152 increases the amount of setup time for the surgery. Altering the right side 128 of the Event B 104 to the left 150 decreases the amount of setup time for the surgery. Altering the Event B 104 in either direction affects the amount of time allocated to the Event C 106, which has an effect on the boxes contained within it (the Events E 114 and H 120). If warning indicators are displayed when the Event C 106 is altered, the user should alter the other connected events (E 114, H 120, or B 104) until no warning indicators are displayed. Once no more alterations are required, the user can accept the changes. At any time the user can reject the changes.

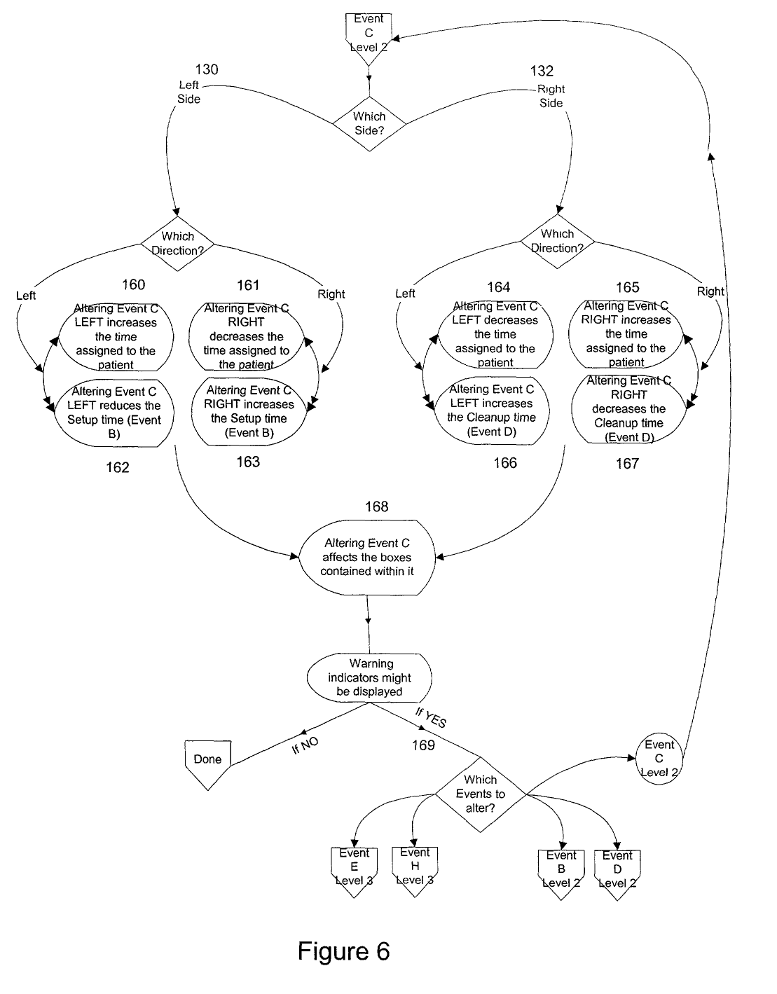

FIG. 6 is a flow chart representation of what happens when a user alters the Event C 106 in accordance with a preferred embodiment of the invention. The Event C 106 represents the amount of time allocated to the patient during the surgery. The total amount of patient time is made up of one or more panels (represented by the Events E 114 and H 120). Altering the left side 130 of the Event C 106 either increases 160 or decreases 161 the amount of patient time by increasing 163 or decreasing 162 accordingly the amount of setup time. Altering the right side 132 of the Event C 106 either increases 165 or decreases 164 the amount of patient time by increasing 166 or decreasing 167 accordingly the amount of cleanup time. Altering 168 the Event C 106 can have an affect on the Events B 104 and D 108 as well as all the boxes contained within it (the Events E 114 and H 120). If warning indicators are displayed when the Event C 106 is altered 169, the user should alter the other connected events (E 114, H 120, B 104 or D 108) until no warning indicators are displayed. Once no more alterations are required, the user can accept the changes. At any time the user can reject the changes.

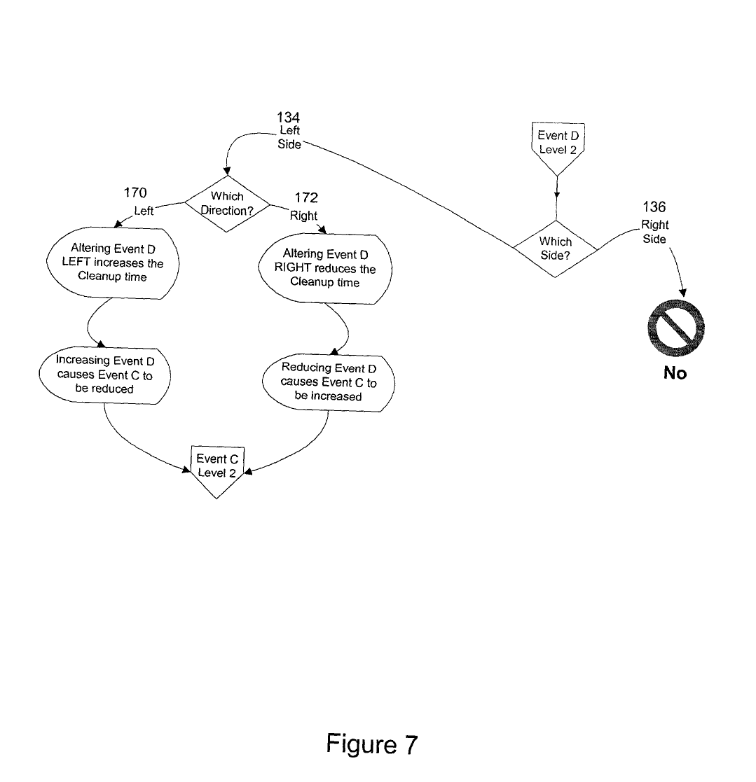

FIG. 7 is a flow chart representation of what happens when a user alters the Event D 108 in accordance with a preferred embodiment of the invention. The Event D 108 represents the amount of cleanup time need for a surgery, thus the right side 136 of its box corresponds to the right side 112 of the Event A 102, which represents the end of the surgery. Because the right side 136 of the Event D 108 corresponds to the end of the surgery, it cannot be altered. Altering the left side 134 of the Event D 108 to the left 170 increases the amount of cleanup time for the surgery. Altering the left side 134 of the Event D 108 to the right 172 decreases the amount of cleanup time for the surgery. Altering the Event D 108 in either direction affects the amount of time allocated to the Event C 106, which has an effect on the boxes contained within it (the Events E 114 and H 120). If warning indicators are displayed when the Event C 106 is altered, the user should alter the other connected events (E 114, H 120, or D 108) until no warning indicators are displayed. Once no more alterations are required, the user can accept the changes. At any time the user can reject the changes.

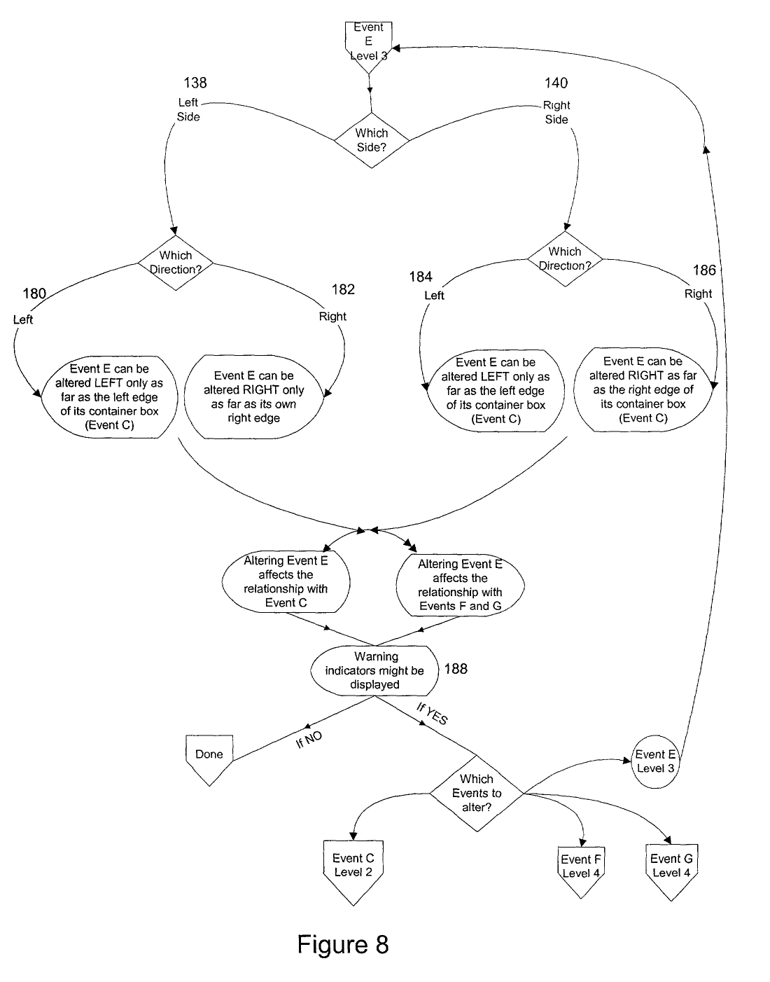

FIG. 8 is a flow chart representation of what happens when a user alters the Event E 114 in accordance with a preferred embodiment of the invention. The Event E 114 represents the amount of time allocated to the first panel in a surgery. A panel is made up of one or more surgical procedures performed on the patient, and the surgeons performing the procedure(s). The left side 138 of the Event E 114 can be altered left 180 as far as the container box (the Event C 106) will allow and right 182 as far as its own right edge 140. However, the left side of one or more panels (the Events E 114 and H 120) must begin at the left side 130 of the Event C 106 or warning indicators will be displayed 188. The right side 140 of the Event E 114 can be altered left 184 or right 186 as far as the containing box (the Event C 106) will allow. However, one of the panels (the Events E 114 and H 120) must end at the right side 132 of the Event C 106 or warning indicators will be displayed 188. Altering the Event E 114 also affects the boxes contained within it (the Events F 116 and G 118). If warning indicators are displayed 188 when the Event E 114 is altered, the user should alter the other connected events (C 106, F 116, or G 118) until no warning indicators are displayed. Once no more alterations are required, the user can accept the changes. At any time the user can reject the changes.

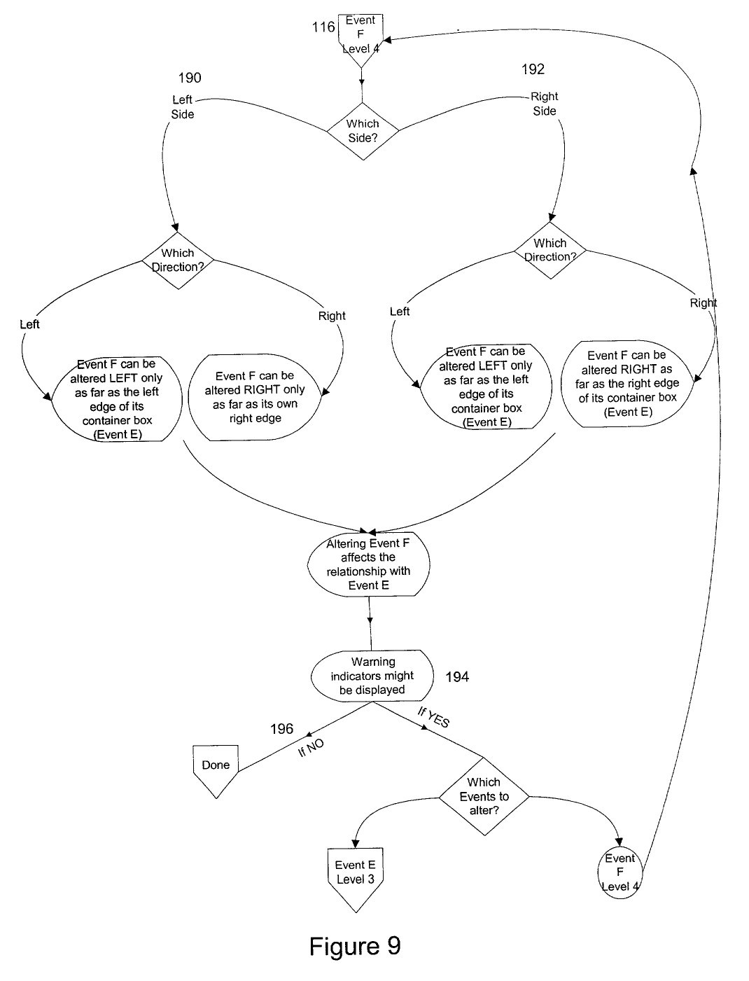

FIG. 9 is a flow chart representation of what happens when a user alters the Event F 116 in accordance with a preferred embodiment of the invention. The Event F 116 represents one or more procedures within the first panel (the Event E 114). The Event F 116 can be altered left 190 or right 192, but it cannot exceed the amount of time allocated to the panel. However, the amount of time allocated to the procedures should equal the amount of time allocated to the panel or warning indicators will be displayed. If there is only one procedure in a panel, it should equal the panel time. The Events E 114 and F 116 should be altered until no warning indicators are displayed 196, then the user can accept the changes. At any time the user can reject the changes.

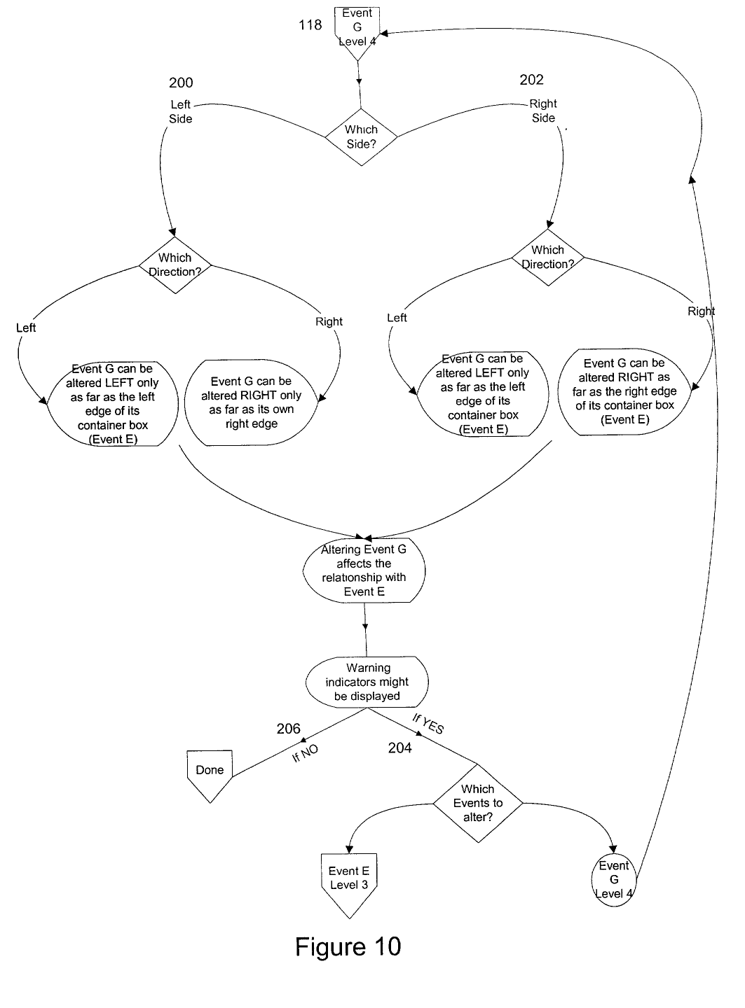

FIG. 10 is a flow chart representation of what happens when a user alters the Event G 118 in accordance with a preferred embodiment of the invention. The Event G 118 is represents the surgeon required to perform the procedures within the first panel (the Event E 114). In FIG. 1 there is only one surgeon per panel, but there might be multiple surgeons. The Event G 118 can be altered left 200 or right 202, but it cannot exceed the amount of time allocated to the panel. Also, the amount of time allocated to the surgeon(s) should equal the amount of time allocated to the panel or warning indicators will be displayed 204. If there is only one surgeon in a panel, the corresponding event's time should equal the panel's time. The Events E 114 and G 118 should be altered until no warning indicators are displayed 206, then the user can accept the changes. At any time the user can reject the changes.

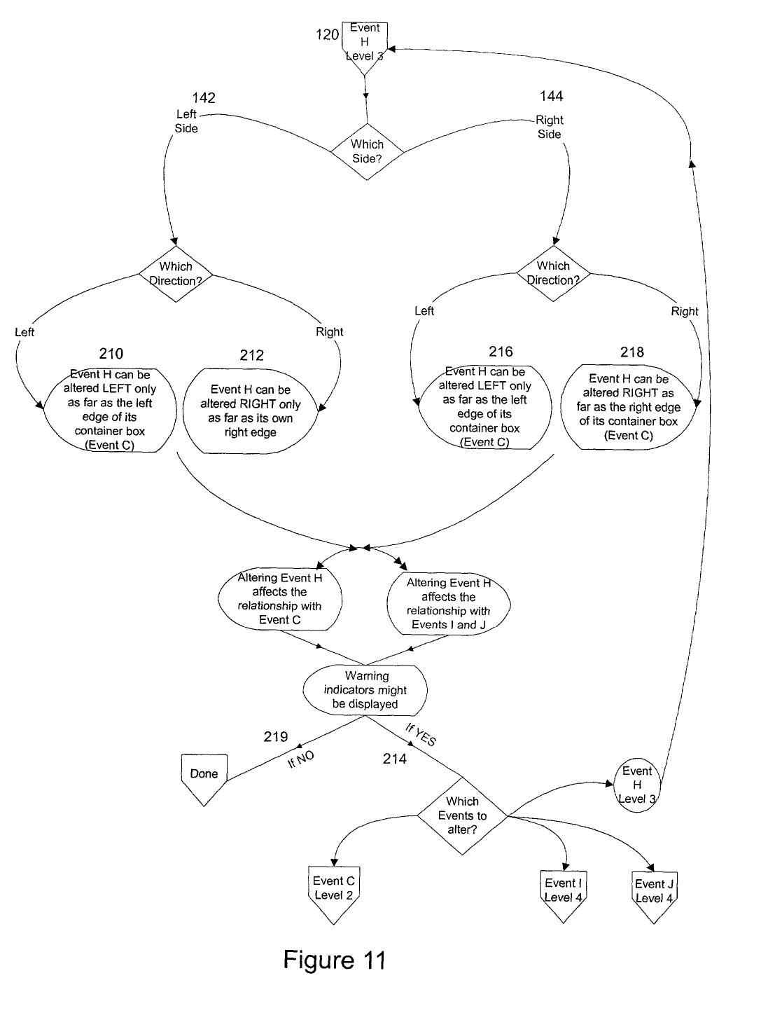

FIG. 11 is a flow chart representation of what happens when a user alters the Event H 120 in accordance with a preferred embodiment of the invention. The Event H 120 represents the amount of time allocated to the second panel in a surgery. A panel is made up of one or more surgical procedures performed on the patient, and the surgeons performing the procedure(s). The left side 142 of the Event H 120 can be altered left 210 as far as the container box (the Event C 106) will allow and right 212 as far as its own right edge 144. However, the left side of one or more panels (the Events E 114 and H 120) must begin at the left side 130 of the Event C 106 or warning indicators will be displayed 214. The right side 144 of the Event H 120 can be altered left 216 or right 218 as far as the containing box (the Event C) will allow. However, one of the panels (the Events E 114 and H 120) must end at the right side 132 of the Event C 106 or warning indicators will be displayed 214. Altering the Event H 120 also affects the boxes contained within it (the Events I 122 and J 124). If warning indicators are displayed when the Event H 120 is altered, the user should alter the other connected events (C 106, I 122, or J 124) until no warning indicators are displayed 219. Once no more alterations are required, the user can accept the changes. At any time the user can reject the changes.

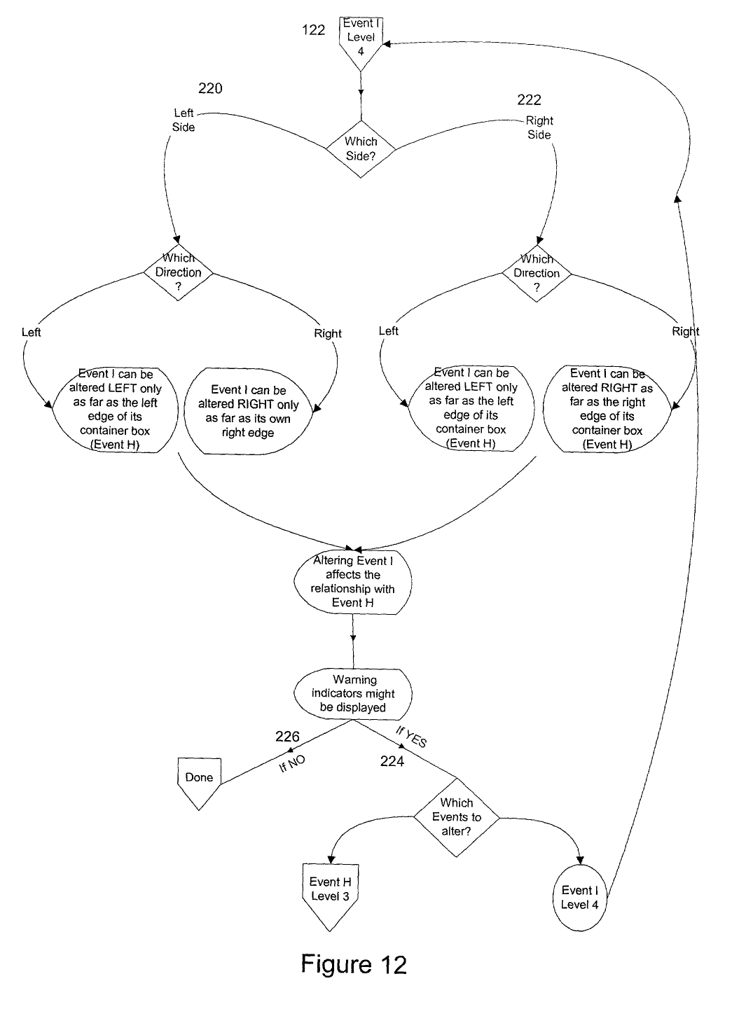

FIG. 12 is a flow chart representation of what happens when a user alters the Event I 122 in accordance with a preferred embodiment of the invention. The Event I 122 represents one or more procedures within the second panel (the Event H 120). The Event I 122 can be altered left 220 or right 222, but it cannot exceed the amount of time allocated to the panel. However, the amount of time allocated to the procedures should equal the amount of time allocated to the panel or warning indicators will be displayed 224. If there is only one procedure in a panel, it should equal the panel time. The Events H 120 and I 122 should be altered until no warning indicators are displayed 226, then the user can accept the changes. At any time the user can reject the changes.

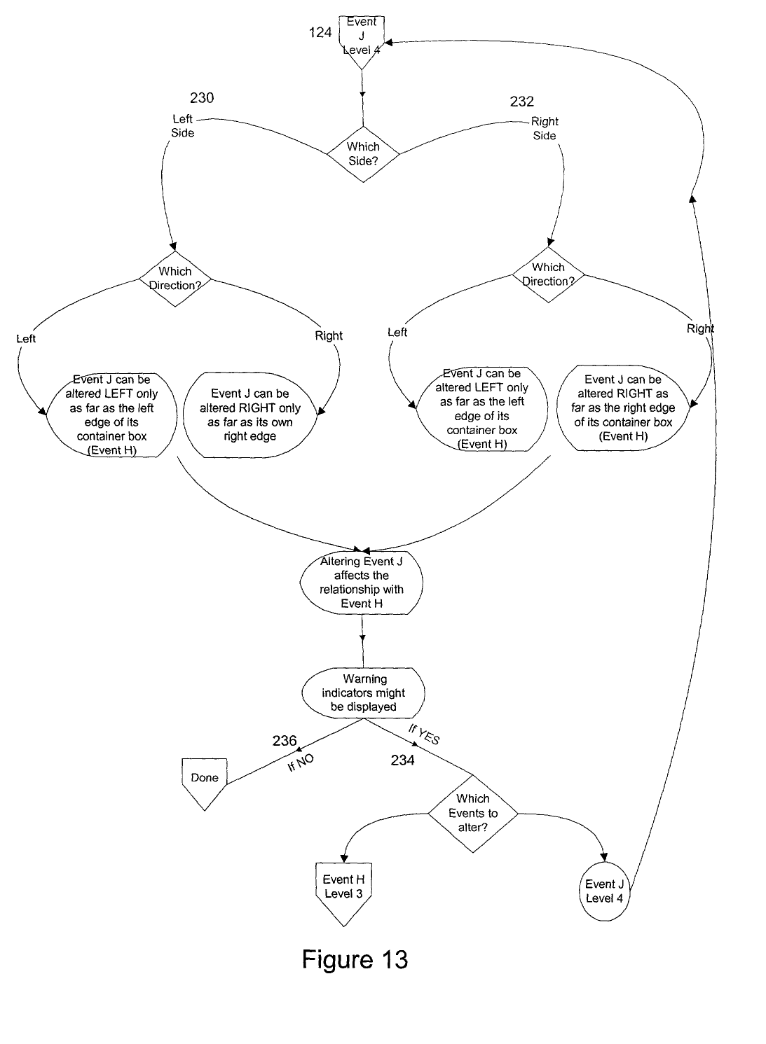

FIG. 13 is a flow chart representation of what happens when a user alters the Event J 124 in accordance with a preferred embodiment of the invention. The Event J 124 represents the surgeon required to perform the procedures within the second panel (the Event H 120). In FIG. 1 there is only one surgeon per panel, but there might be multiple surgeons. The Event J 124 can be altered left 230 or right 232, but it cannot exceed the amount of time allocated to the panel. Also, the amount of time allocated to the surgeon(s) should equal the amount of time allocated to the panel or warning indicators will be displayed 234. If there is only one surgeon in a panel, the corresponding event's time should equal the panel's time. The Events H 120 and J 124 should be altered until no warning indicators are displayed 236, then the user can accept the changes. At any time the user can reject the changes.

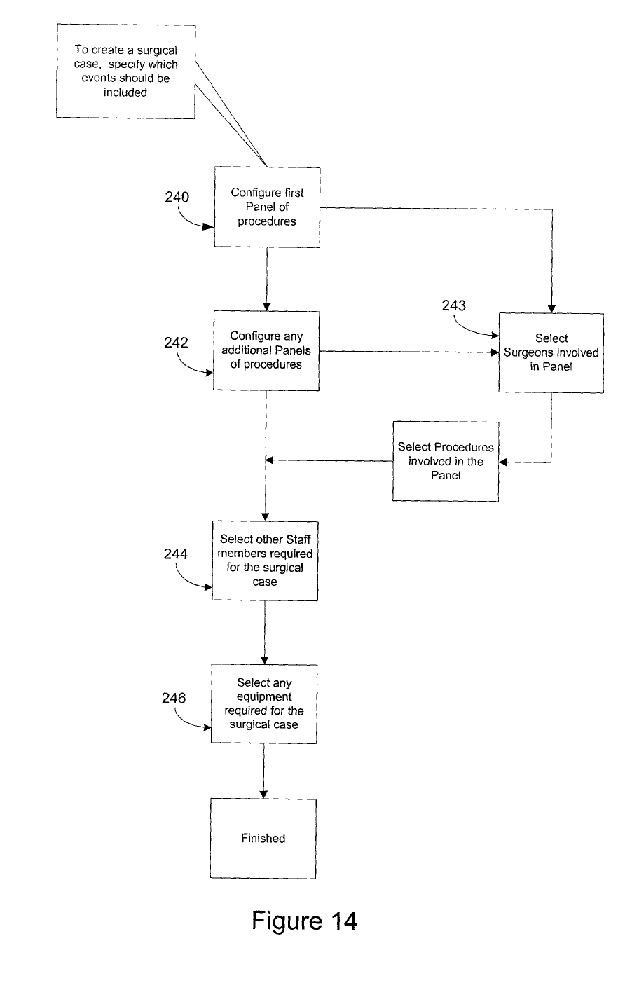

FIG. 14 is a flowchart representation of the steps required to create a surgical case in accordance with a preferred embodiment of the invention. Creating a case is essentially the process of indicating which events will be involved. For example, in an operating room, this would mean specifying which people should be involved, which procedures should be performed, and who should perform those procedures. The first part of the process involves the creation of panels 240 and 242, which are simply a way to group the surgical procedures involved. A component in configuring additional panels includes a step 243 of selecting the surgeons performing those procedures. After the required panels have been created, a next step 244 comprises a user selecting any other staff members who will need to be present, such a nurses or anesthesiologists. A further step includes selecting any equipment 246 that will need to be present, such as an x-ray machine. After the required events have been indicated, a user may use the visual system to orchestrate the time relationships between them.

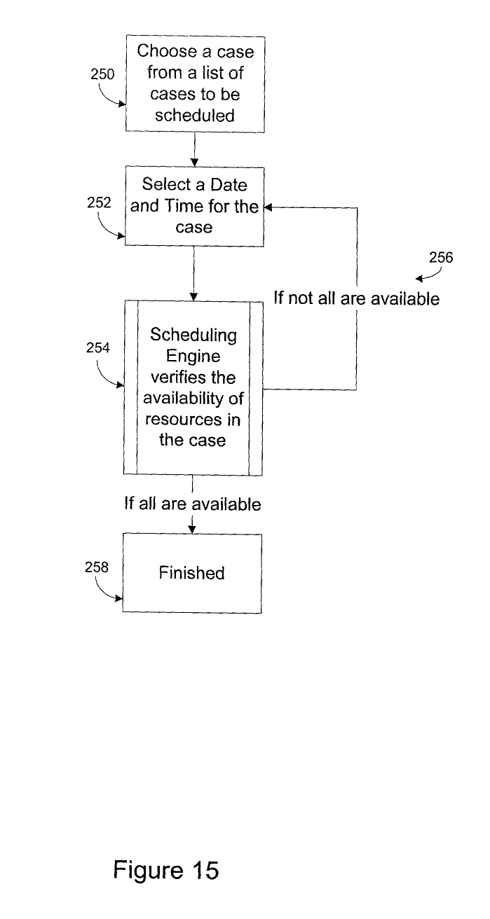

FIG. 15 is a flowchart representation of the steps required to schedule a surgical case in accordance with a preferred embodiment of the invention. After all of the proper relationships between the events have been determined, the case can actually be scheduled. A first step 250 typically requires a user to choose a case from a list of waiting cases. A second step 252 includes fitting that case into an appropriate time slot. Whenever the user selects a time slot, in a next step 254, a behind the scenes scheduling engine evaluates the availability of all the events involved in the case and determines whether the case can be scheduled at that time. If one or more of the events is unavailable 256, the user is notified and must choose a new time. Otherwise, the case is scheduled 258 and the user is finished.

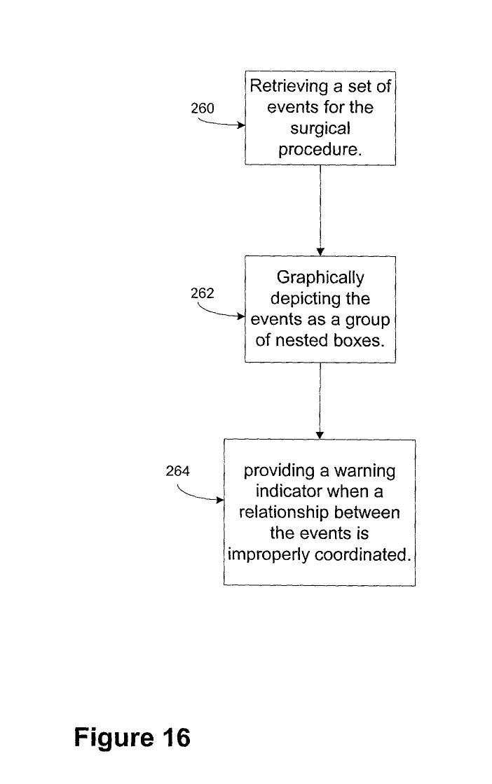

FIG. 16 is a flowchart representation of some of the steps necessary to build a surgical case for a patient. These steps take into account the preferences of an identified surgeon. A first step 260 includes retrieving a set of events for the surgical case. If necessary, the step 260 may also include modifying the set of events to develop a modified set of events for the case that are complete and accurate. The required events are characterized by a set of preferences that are determined by the surgeon and the hospital or facility. A next step 262 includes graphically depicting the events as a group of nested boxes. Visually depicting the events in this manner allows a user to coordinate the relationships between the events to develop a coordinated surgical case. In the step 262, the widths of the nested boxes correspond to quantities of time allocated to a given event. Additionally, the beginning of an event is represented by the left edge of a box and the end of an event is represented by the right edge of the box. Because of the correlation between the boxes and the events, the boxes are thus used to represent an amount of time allocated to a person, a resource, or a procedure. A step 264 provides a warning indicator when a relationship between the events is improperly coordinated. This warning indicator appears as a red hatching within the boxes at issue when there is, for example, impermissible overlap or inadequate representation of a person or resource.

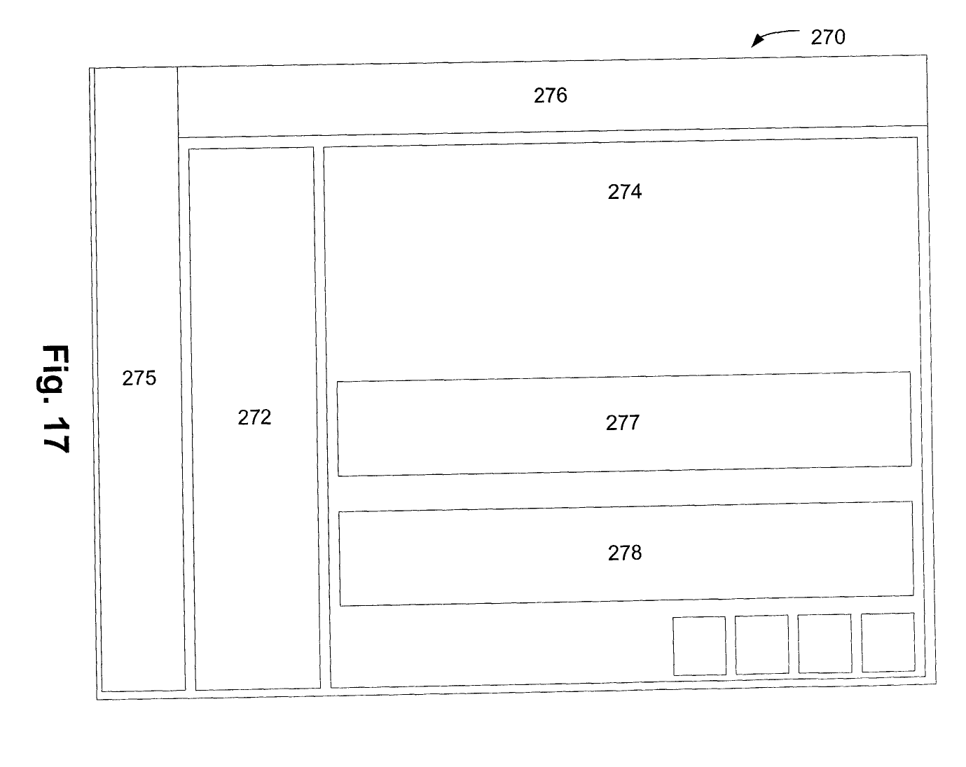

The environment to build a surgical case for a patient may be implemented in a stand alone software program and it may be configured to appear to the user as a web page. The environment may be configured to reside on an individual user's computer, or it may be accessed remotely through a data line such as the internet for example. FIG. 17 illustrates just such an exemplary web page configured as a General Case Information entry page 270. The page 270 is split with an activity menu 272 on a left hand side of the page 270 and a Case Information panel 274 on a right hand side. The page 270 may also include an activity status block 275 and a menu section 276. The activity menu may include options such as general case information, staffing, equipment and instruments, supplies and drugs, anesthesia information, additional case information, nursing instructions, scheduling instructions, patient instructions, audit trail, etc. The Case Information panel 274 facilitates the initial entry of information required to begin the process of creating the surgical case. For example, the Case Information panel 274 may allow entry of the patient's name, the proposed date of the case, the surgical service, the location or facility, etc. The Case Information panel 274 may also include a surgeon panel 277 and a procedure panel 278. While not specifically shown, the Case Information panel 274 may also allow the user to input the estimated times for a few major events in the overall procedure, such as a time required for setup, a time required for cleanup and a time allocated for the surgeon.

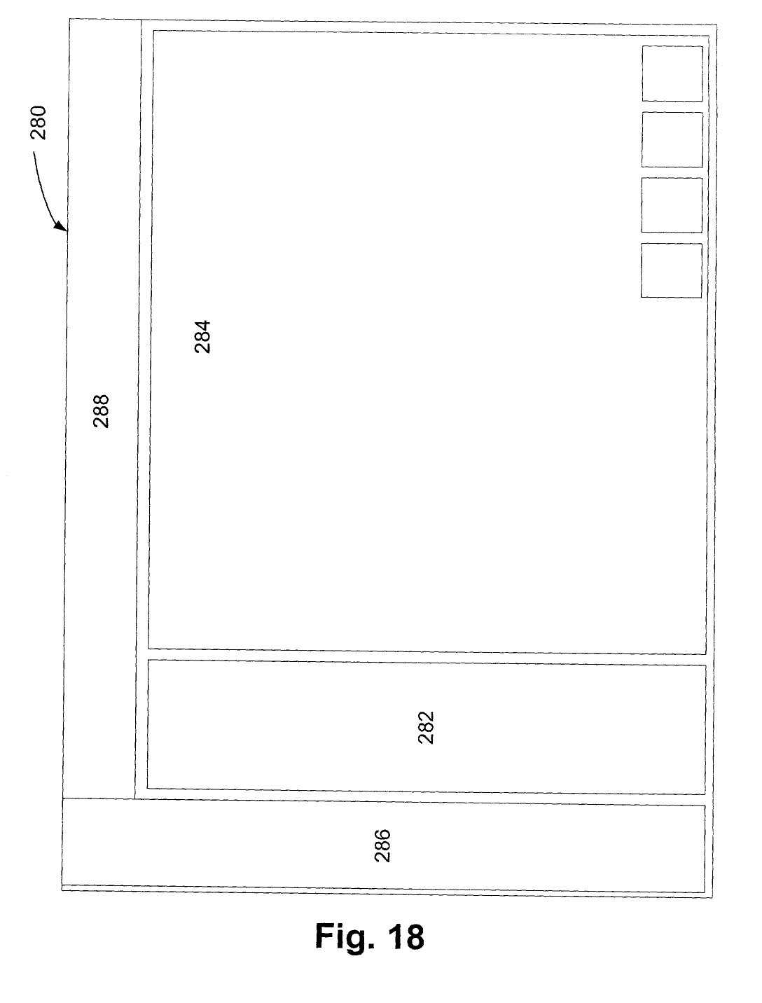

FIG. 18 illustrates an exemplary web page for entering a case that is configured as a Staff Information entry page 280. Similar to the General Case Information entry page 270, the page 280 may also have a split with an activity menu 282 on a left hand side of the page 280 and a Staff Information panel 284 on a right hand side. Additionally, the page 280 may have an activity status block 286 and a menu 288. The Staff Information panel 284 facilitates the entry of information related to the staff required for the procedure. An example of personnel included may be a circulating nurse, a scrub nurse, a head nurse, an OR technician, etc. Through page 280, a user enters numeric values for the start time and end time of each staff person. These times are relative to one another, but not yet related directly to a specific time of day. For example, if the time required for the Scrub Nurse is entered as “60” for the start time and “120” for the end time, it signifies that the Scrub Nurse is scheduled to enter the operating room one hour after the beginning of the procedure (most likely after the patient has been prepared for surgery), and will remain in the operating room for one hour before being scheduled to leave.

The page 280 displays the staff that was retrieved from a database for the associated surgical procedures. The staff information is a combination of the personnel required by the facility and previously entered by the facility, as well as the personnel preferred by the surgeon to be present during the case. If the facility or the surgeon had not previously entered their staff preferences, the user would be provided a template that would include the staff required for similar procedures, and add or delete staff positions as required until a complete and accurate list is compiled.

FIG. 19 illustrates an exemplary case planning system for coordinating multiple, interdependent events that is configured as a coordination page 290. The page 290 visually depicts the information from the General Case Information entry web page 270, the Staff Information entry page 280, and any other web pages used to enter a case, as a group of nested boxes. The page 290 is split with a list of a set of preferences 292 on a left hand side of the page 290 and a group of nested boxes 294 comprising a number of events on a right hand side. The list of preferences 292 may include for example, the operating room, the patient, the procedure, the surgeon, the circulating nurse, the scrub nurse, the head nurse, the OR technician, etc. The display of nested boxes allows the user to view and better comprehend the relationships between the events.

The exemplary case planning system 290 allows the user to coordinate the relationships between the events by using a peripheral device, such as a mouse, to modify the events by expanding or shrinking the size of the boxes. The user is also allowed to modify an event by use of a number of expand buttons 296, 298, and 300. For example, with the use of a peripheral device, the user may click on an event and then click on the left stretch button 296 to expand the selected event to a left edge of the next larger containing box. The right stretch button 300 can perform a similar expansion to the right. The left/right stretch button 298 expands the selected box in both directions, so that the duration of both events is the same. In other words, the left/right stretch button 298 will ensure that the selected event and the next larger containing box will start and end at the same time. It should also be noted that times in the case planning system 290 may represent relative times because the case has not yet been “scheduled” and the relative times have not yet been converted to actual times of the day.

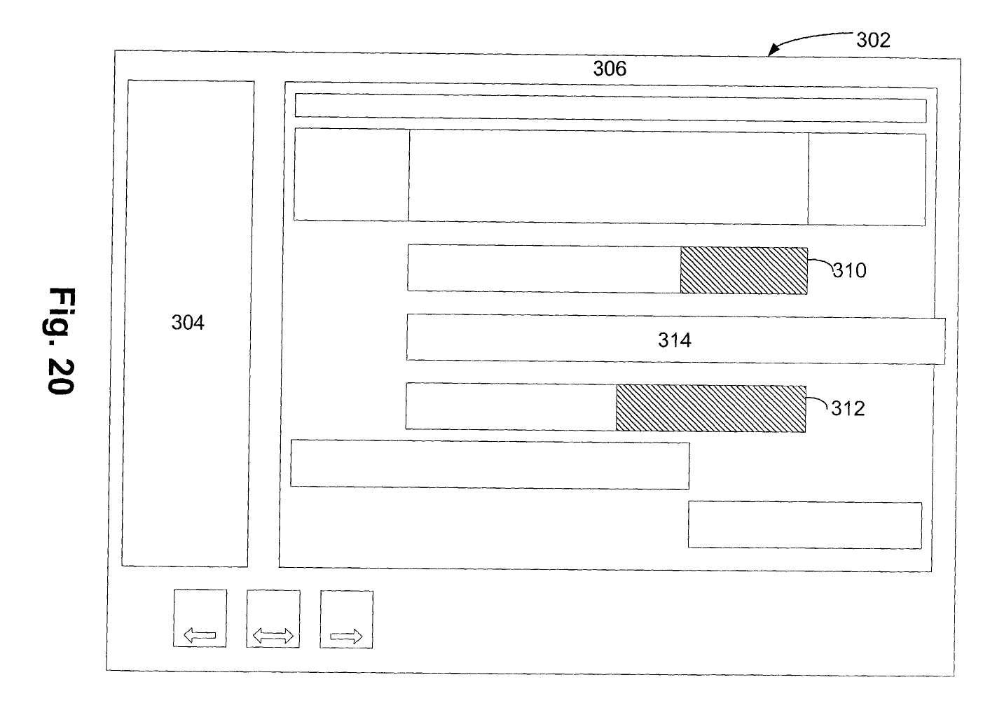

FIG. 20 illustrates an exemplary case planning system for entering a case that is configured as a coordination page 302 wherein a number of relationships between events are improperly coordinated and a number of resulting warning indicators are present. As with the coordination page 290, the page 302 is split with a list of a set of preferences 304 on a left hand side of the page 302 and a group of nested boxes 306 comprising a number of panels on a right hand side. Here, the display of nested boxes include a first box 310 and a second box 312 having colored hatchings or parallel lines to warn the user that the events are improperly coordinated. The event 312 is improperly coordinated because the width of the box or the time scheduled for a surgeon does not extend far enough to the right to coincide with the right edge of the event for the surgical procedure. In most surgical procedures, the surgeon is required to be present throughout the surgery. Thus, a warning is provided here. A box 314 may include text that is highlighted in red to indicate an improper relationship. The box 314 extends to the right beyond the right edge of the box that should be containing the box 314. While the alert here uses colored text to warn the user that this is an improper relationship is present, it may also use hatchings to alert the user.

Although the technique for coordinating multiple, interdependent events described herein is preferably implemented in software, it may be implemented in hardware, firmware, etc., and may be implemented by any other processor associated with the organization. Thus, the routines described herein may be implemented in a standard multi-purpose CPU or on specifically designed hardware or firmware as desired. When implemented in software, the software routine may be stored in any computer readable memory such as on a magnetic disk, a laser disk, or other storage medium, in a RAM or ROM of a computer or processor, etc. Likewise, this software may be delivered to a user or a process control system via any known or desired delivery method including, for example, on a computer readable disk or other transportable computer storage mechanism or over a communication channel such as a telephone line, the internet, etc. (which are viewed as being the same as or interchangeable with providing such software via a transportable storage medium).

The invention has been described in terms of several preferred embodiments. It will be appreciated that the invention may otherwise be embodied without departing from the fair scope of the invention defined by the following claims.

We claim:

1. A method of building a surgical case for a patient and an identified surgeon comprising the steps of:
retrieving a set of events for the surgical case;
graphically depicting the events as a group of nested boxes; and
providing a warning indicator when a relationship between the events is improperly coordinated.

2. The method of claim 1, wherein the step of retrieving the set of events for the surgical case includes contacting a database to obtain the set of events.

3. The method of claim 1, further comprising a step of selecting a date and time to schedule the surgical case.

4. The method of claim 1, further comprising a step of coordinating the relationships between the events to develop a coordinated case.

5. The method of claim 4, further comprising a step of forwarding the coordinated case to a scheduling engine.

6. The method of claim 1, further comprising a step of modifying the set of events to develop a modified set of events for the surgical case.

7. The method of claim 6, wherein the step of modifying the set of events includes adding additional events.

8. The method of claim 6, wherein the modified set of events includes a complete and accurate set of events that are based on a set of preferences.

9. The method of claim 1, wherein the events are characterized by a set of preferences.

10. The method of claim 9, wherein a facility or the surgeon determines the set of preferences.

11. The method of claim 1, further comprising a step of verifying the availability of a set of resources required for the surgical case.

12. The method of claim 1, wherein the step of providing an alert indicator comprises adding a colored hatching to at least one of the boxes.

13. The method of claim 1, wherein the step of providing an alert indicator comprises changing the appearance of a box by adding a warning symbol.

14. The method of claim 1, wherein the step of graphically depicting the events as a group of nested boxes includes corresponding the width of the boxes to quantities of time.

15. The method of claim 1, wherein the step of graphically depicting the events as a group of nested boxes includes using the boxes to represent an amount of time allocated to a person, a resource, or a procedure.

16. The method of claim 1 wherein the step of graphically depicting the events as a group of nested boxes includes representing the total amount of time required for a surgical case by a box that is larger than any other box.

17. The method of claim 4 wherein the step of coordinating the relationships between the events includes warning a user when a smaller contained box is expanded beyond the edge of a larger containing box.

18. The method of claim 1 wherein the step of graphically depicting the events as a group of nested boxes includes using a peripheral device to expand or shrink the size of a box by selecting and dragging an edge of the box.

19. The method of claim 1 wherein the step of graphically depicting the events as a group of nested boxes includes representing the beginning of an event with a left edge of a box and the end of an event with a right edge of the box.

20. The method of claim 1 wherein the events comprise a setup time for a surgery, a time allocated to a patient for the surgery, and a time allocated for cleaning up after the surgery.

21. A computer routine for building a surgical case for a patient and an identified surgeon, comprising:
a first routine for retrieving a set of events for the surgical case;
a second routine for graphically depicting the events as a group of nested boxes; and
a third routine for providing an alert indicator when a relationship between the events is improperly coordinated.
